(19) United States
(12) Patent Application Publication
(10) Pub. No.: US 2008/0307934 A1
(43) Pub. Date: Dec. 18, 2008

(54) Multi-purpose cable crimping tool

(75) Inventor: Stan Coe, Raleigh, NC (US)

Correspondence Address: THE HECKER LAW GROUP, 1925 CENTURY PARK EAST, SUITE 2300, LOS ANGELES, CA, 90067, US

(73) Assignee: RGB Systems, Inc.

(21) Appl. No.: 11/818,902

(22) Filed: Jun. 14, 2007

(51) Int. Cl. B25B 27/00; B21D 37/14

(52) U.S. Cl. 81/426; 72/416

(57) ABSTRACT

A multi-purpose cable crimpring tool includes upper and lower dies configured to compress and deform various types of cable ferrules and/or core pins. When brought together, the upper and lower dies are configured to form a plurality of cable crimping cavities. Some cable crimping cavities are shaped as irregular polygons to allow substantially even distribution of swage loads on a cable ferrule being compressed and deformed therein.

### FIELD OF THE INVENTION

The present invention relates generally to tools for terminating transmission cables. More specifically, the invention relates to a multi-purpose cable crimping tool.

### BACKGROUND

Conventional cable crimping tools consist of a pair of appropriately configured steel blocks or dies that are compressed together by pivoting jaws of a hand-powered toggle clamp. FIG. 1A is a cross-sectional view of a portion of the jaws of a conventional cable crimping tool 20 before clamping action by the user. Conventional crimping tool 20 includes upper and lower dies 22, 24, respectively, that are configured to compress and deform cable ferrule 26 when brought together when the handles of the crimping tool are compressed, causing the jaws to rotate together about a pivot. In this regard, FIG. 1A schematically shows a pivot 28 operatively disposed to the left of upper and lower dies 22, 24. One half of a regular hexagonal cavity (30a, 30b) is formed into each die (22, 24) such that when upper and lower dies 22, 24 are closed, the full crimping cavity forms a regular hexagon 30 (FIG. 1B).

Upper steel block 22 defines a first die mating plane 32 defined by right and left bottom die edges 34, 36, respectively, as generally shown in reference to FIG. 1A. Similarly, lower steel block 24 defines a second die mating plane 38 defined by right and left top die edges 40, 42, respectively (FIG. 1A). Upper cavity lateral sides 44, 46 are slightly curved at their respective junctions 45, 47 (FIG. 1A) with first die mating plane 32 to facilitate crimping action. On the opposite side, lower cavity lateral sides 48, 50 are respectfully slightly curved at their respective junctions 49, 51 (FIG. 1A) with second die mating plane 38. Upper cavity side 52, which is disposed between lateral sides 44, 46, is generally parallel to first die mating plane 32 as a result of the regular hexagon cavity configuration in conventional crimping tool 20. Similarly, lower cavity side 54, which is disposed between lateral sides 48, 50, is generally parallel to second die mating plane 38 (FIG. 1A).

Because the clamping jaws are pivoted, when upper and lower dies 22, 24 are closed around a cylindrical ferrule (before clamping), first and second die mating planes 32, 38 are not parallel, but are generally divergent at an angle that decreases as the jaws are brought together, as depicted in reference to FIG. 1A. This planar divergence causes the asymmetrical loading on two sides of the ferule. Particularly, the relative distance between left side initial contact points 56a, 56b (which are closer to pivot 28 than right side initial contact points 58a, 58b) is smaller than the corresponding relative distance between right side initial contact points 58a, 58b. These initial points of contact initiate a drag load M (that is perpendicular to the respective planes defined by lateral cavity sides 44, 46, 48, 50) to swage the outer wall of ferrule 26 as upper and lower dies 22, 24 rotate about pivot 28 compressing and deforming ferrule 26.

Drag loads M (FIG. 1A) are not the same on each side of the ferule because right side initial contact points 58a, 58b are required to move significantly more material during crimping action than left side initial contact points 56a, 56b. As a result of the asymmetrical drag loads M, upper and lower dies 22, 24 often pinch a small amount of ferrule metal at the part line on one or both sides of the ferule, resulting in a sharp flash 60 (FIG. 1B) projecting from crimped cable ferrule 26. The precise sizing of the die cavity relative to ferrule 26 contributes to flash formation if it is too small. If the die cavity is too large, the cable is not sufficiently secured when crimped. Sharp flash 60 (FIG. 1B) is undesirable due to personal injury hazard and also due to interference with a molded polymer sleeve that typically slides over cable ferrule 26 to finish the installation of the connector to the cable.

The need exists, therefore, for an improved crimping tool that eliminates flash formation while providing enough clamping force to securely connect the cable to its respective connector.

### SUMMARY OF THE INVENTION

Some embodiments disclosed herein are generally directed to a multi-purpose cable crimping tool. In accordance with one or more embodiments of the present invention, a cable crimping tool comprises an upper die, and a lower die that is operatively coupled to the upper die. The upper and lower dies are configured to jointly form a plurality of cable crimping cavities. In one or more embodiments, at least one of the cable crimping cavities is shaped as an irregular hexagon to allow the distribution of swage loads on a connector portion being compressed and deformed therein in a substantially symmetrical fashion.

In one or more embodiments, the plurality of cable crimping cavities includes cavities for crimping RG59, RG6, M59 (Mini 59) and MHR (Mini Hi Rez) connectors.

In one or more embodiments, the plurality of cable crimping cavities includes cavities for crimping M59 and MHR/RG core pins.

These and other aspects of the invention will become apparent from a review of the accompanying drawings and the following detailed description of the invention.

### BRIEF DESCRIPTION OF THE DRAWINGS

FIG. 1A is a cross-sectional view of a portion of a conventional cable crimping tool before clamping action by the user;

FIG. 1B is a cross-sectional view of a portion of a conventional cable crimping tool after clamping action by the user;

FIG. 2A is a rear perspective view of a multi-purpose cable crimping tool in an open state in accordance with one embodiment of the present invention;

FIG. 2B is a front perspective view of the multi-purpose cable crimping tool of FIG. 2A;

FIG. 3 is a side elevation of one component of the multi-purpose cable crimping tool of FIG. 2B;

FIG. 4A is a side elevation of the multi-purpose cable crimping tool of FIG. 2B in a closed state in accordance with an embodiment of the present invention;

FIG. 4B is a side elevation of the multi-purpose cable crimping tool of FIG. 2A in a closed state in accordance with an embodiment of the present invention;

FIG. 5 is a schematic view of a crimping cavity configuration constructed in accordance with an embodiment of the present invention as compared to conventional crimping cavity setup;

FIG. 6 is a side elevation of the multi-purpose cable crimping tool of FIG. 2A in a semi-closed state over a first cable connector in accordance with an embodiment of the present invention;

FIG. 7 is a side elevation of the multi-purpose cable crimping tool of FIG. 2A in a semi-closed state over a second cable connector in accordance with an embodiment of the present invention;

FIG. 8 is a side elevation of the multi-purpose cable crimping tool of FIG. 2A in a semi-closed state over a third cable connector in accordance with an embodiment of the present invention;

FIG. 9 is a side elevation of the multi-purpose cable crimping tool of FIG. 2A in a semi-closed state over a fourth cable connector in accordance with an embodiment of the present invention;

FIG. 10 is a side elevation of the multi-purpose cable crimping tool of FIG. 2A in a fully closed state over a first center pin in accordance with an embodiment of the present invention;

FIG. 11 is a side elevation of the multi-purpose cable crimping tool of FIG. 2A in a fully closed state over a second center pin in accordance with an embodiment of the present invention;

FIG. 12 is a side elevation of the multi-purpose cable crimping tool of FIG. 6 in a fully closed state over the first cable connector in accordance with an embodiment of the present invention;

FIG. 13 is a side elevation of the multi-purpose cable crimping tool of FIG. 7 in a fully closed state over the second cable connector in accordance with an embodiment of the present invention;

FIG. 14 is a side elevation of the multi-purpose cable crimping tool of FIG. 8 in a fully closed state over the third cable connector in accordance with an embodiment of the present invention;

FIG. 15 is a side elevation of the multi-purpose cable crimping tool of FIG. 9 in a fully closed state over the fourth cable connector in accordance with one embodiment of the present invention;

FIG. 16 is a schematic view of a pin crimping configuration in accordance with an embodiment of the present invention;

FIG. 17 is a schematic view of one aspect of the pin crimping configuration of FIG. 16;

FIG. 18 is a schematic view of another aspect of the pin crimping configuration of FIG. 16;

FIG. 19 is a cut-away perspective view of the multi-purpose cable crimping tool of FIG. 2A; and

FIG. 20 is a cross-sectional view showing the multi-purpose cable crimping tool of FIG. 2A being used in accordance with an embodiment of the present invention.

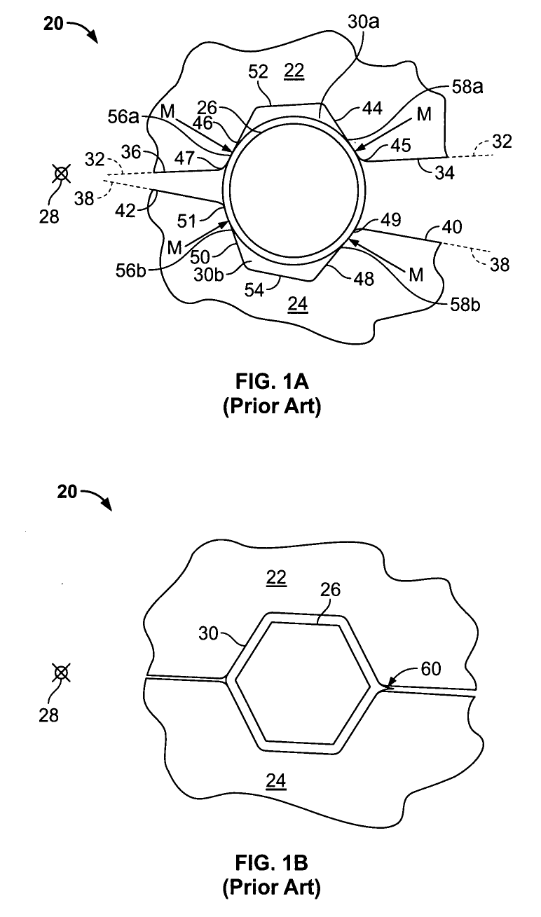

### DETAILED DESCRIPTION OF THE INVENTION

The detailed description set forth below in connection with the appended drawings is intended as a description of illustrated exemplary embodiments and is not intended to represent the only forms in which these embodiments may be constructed and/or utilized. The description sets forth the functions and sequence of steps for constructing and operating the present invention in connection with the illustrated embodiments. However, it is to be understood that the same or equivalent functions and/or sequences may be accomplished by different embodiments that are also intended to be encompassed within the spirit and scope of the present invention.

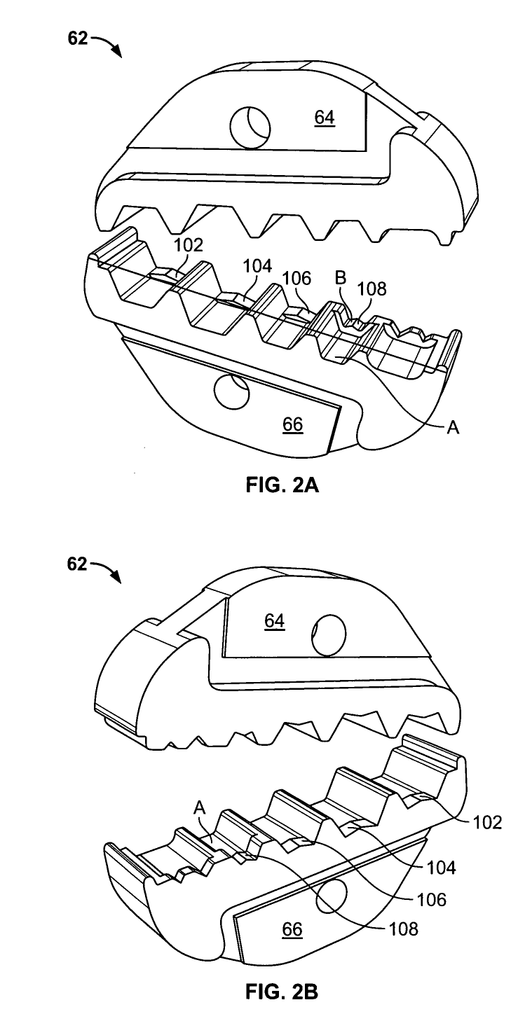

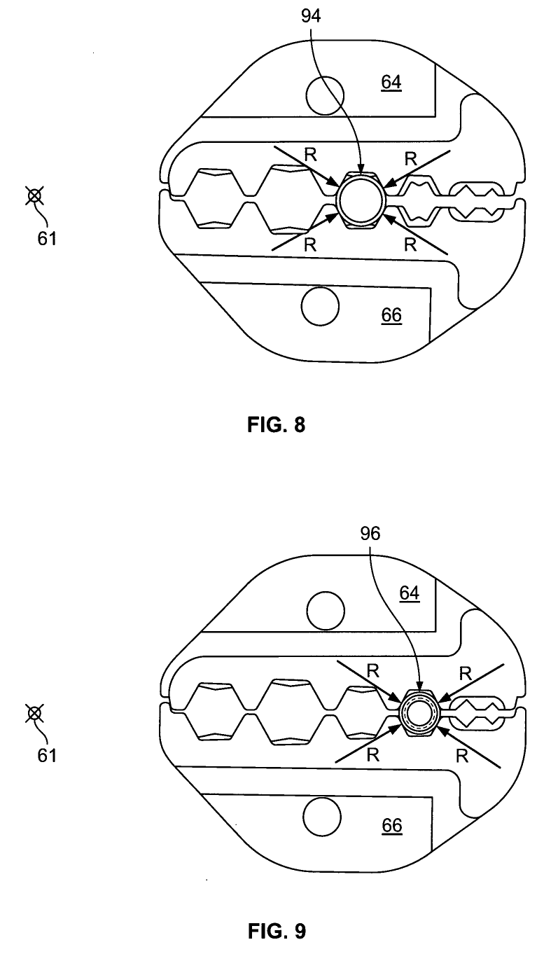

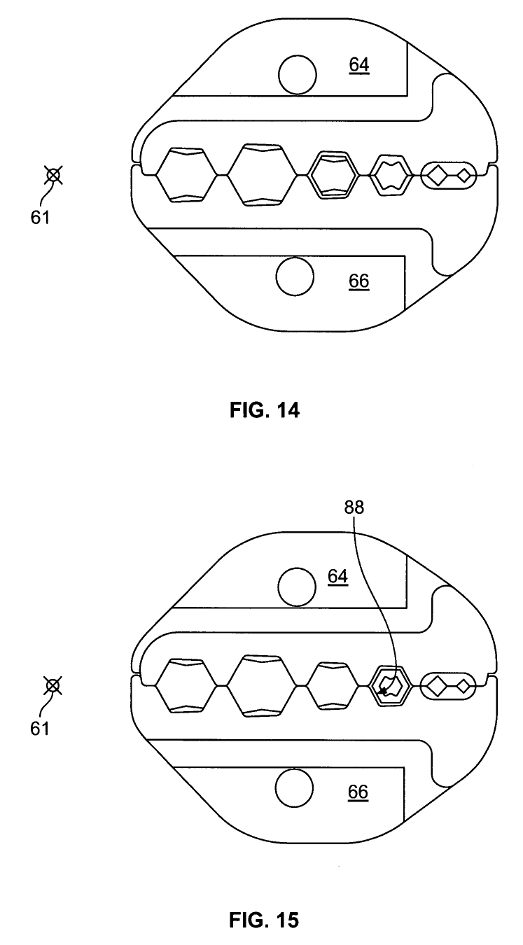

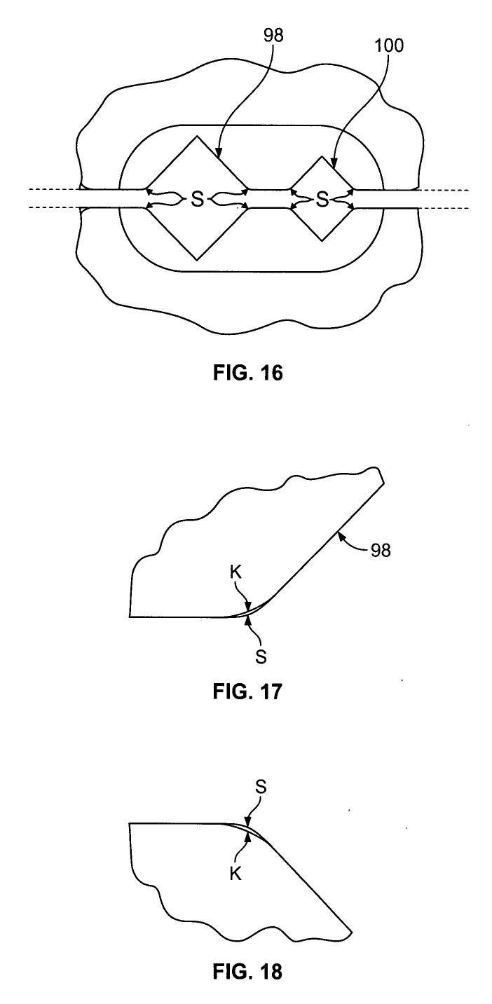

Some embodiments of the present invention will be described in detail with reference to a multi-purpose cable crimping tool, as generally depicted in reference to FIGS. 2A-20. Additional embodiments, features and/or advantages of the invention will become apparent from the ensuing description or may be learned by practicing the invention. In the attached figures, the various drawings are not to scale. Like numerals refer to like features throughout the drawings and the description.

FIGS. 2A-2B show rear and front perspective views, respectively, of jaws of a multi-purpose cable crimping tool 62 in an open state in accordance with one or more embodiments of the present invention. Cable crimping tool 62 includes upper and lower dies 64, 66, respectively, which are configured to compress and deform various types of cable ferrules when brought together. Each of upper and lower dies 64, 66 may be made of steel and/or any other suitable material(s). Upper and lower dies 64, 66 are compressed together by the pivot jaw of a hand powered toggle clamp (not shown).

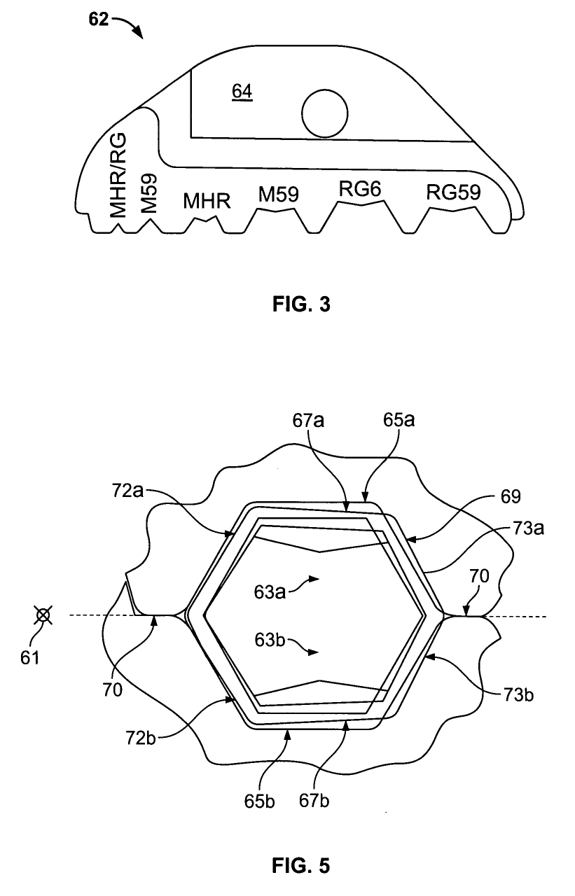

In one or more embodiments, a plurality of cavity sections in each die provides the capability of crimping a center pin onto the center conductor of a coaxial cable and subsequently crimping a ferrule around the shield wires of the cable fastening the same firmly to a respective connector. The purpose of having multiple cavities is to provide a single universal tool that crimps the entire product line of one or more type of connectors. For example, one or more embodiments of the present invention may be configured with four crimping cavities for accommodating RG59, RG6, M59 (Mini 59) and MHR (Mini Hi Rez) connectors, respectively, and two crimping cavities for accommodating M59 and MHR/RG core (center) pins, respectively. In this regard, FIG. 3 schematically shows upper die 64 configured with the aforementioned crimping cavities.

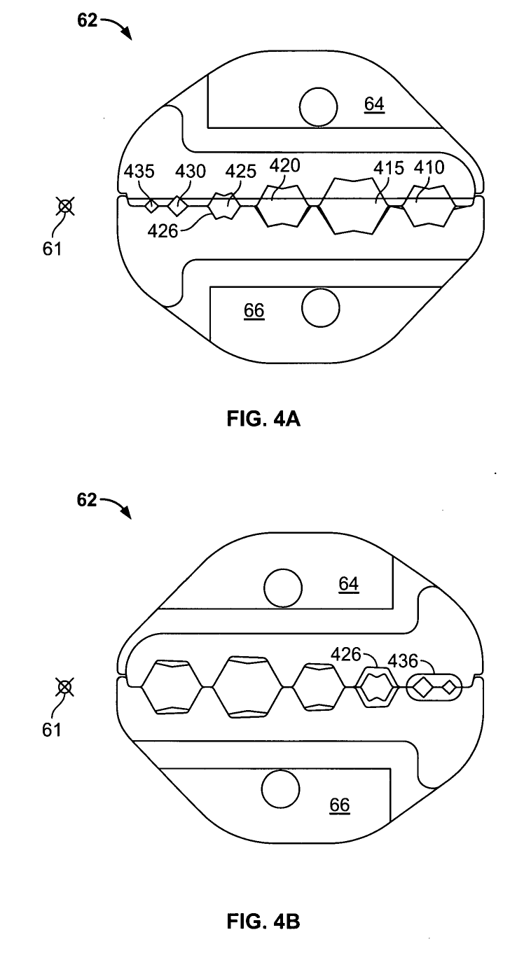

As generally shown in FIGS. 4A-4B, the crimping cavities accommodate different types of coaxial cable. In the embodiment of FIGS. 4A and 4B, cavity 410, which is closest to a pivot 61 (FIG. 4A) is configured to crimp an RG59 connector. The second cavity 415 is for an RG6 connector. The third cavity 420 is for the M59 connector. The fourth cavity 425 is configured to crimp an MHR connector. Cavity 425 comprises a shoulder section on one side of the cavity that forms a narrower cross-section than the remaining cross-section of the cavity. This shoulder section is used to crimp the neck (center) section of the connector, while the larger cross-section portion of the cavity is used to crimp the body section of the connector. The fifth cavity 430 crimps the center pin of a M59 connector, while the sixth cavity 435 crimps the center pin for RG6, RG59 and MHR connectors. In one or more embodiments, the crimping surfaces comprise a portion of the width of the dies, with the remaining width of the dies comprising a clearance cavity 436, as shown in FIG. 4B.

In one of more embodiments, one or more of the crimping cavities are configured as irregular hexagons to improve the quality of the final ferrule crimp. In one or more embodiments, such crimping cavities are utilized for cavities for crimping RG59, RG6, and M59 connectors. In one or more embodiments, as shown in FIG. 5, a hexagonal cavity (65a, 65b) in each die is formed as an irregular hexagon. In one or more embodiments, the irregular hexagon is stretched away from the pivot point as shown by arrows 63a, 63b in FIG. 5. In addition, the top and bottom hexagon faces 67a and 67b, and the lateral faces 73a and 73b furthest away from the pivot point, are each rotated towards each other, so that the differences in the distance between the initial upper and lower contact points of the dies with the ferule on each side of the ferule are reduced.

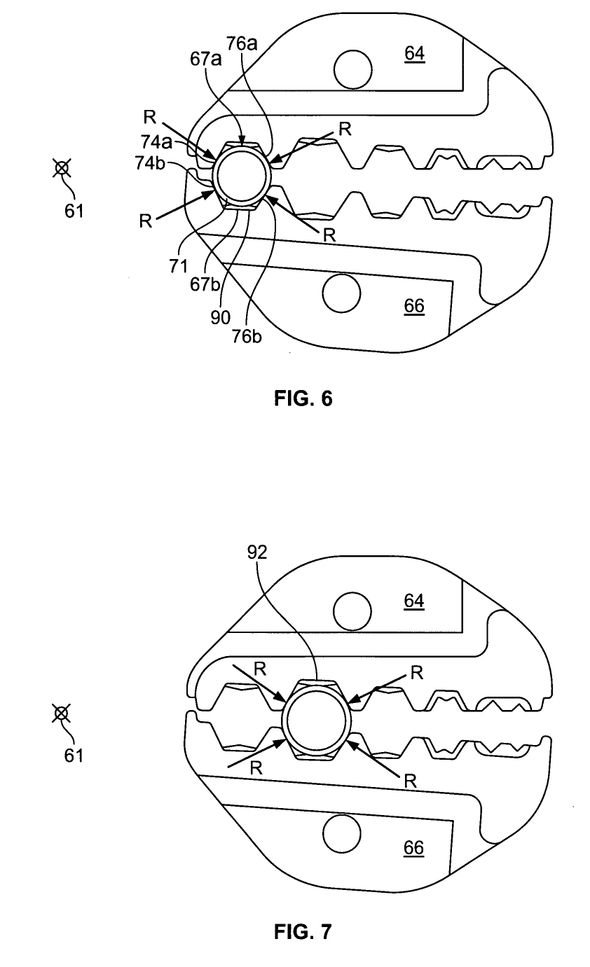

As a result of the rotation, when upper and lower dies 64, 66 are positioned to contact ferrule 71 without deforming it, top and bottom faces 67a, 67b become approximately parallel, and the distances between top and bottom contact points become approximately equal, as shown in FIG. 6.

In one or more embodiments, each of lateral faces 72a, 72b (FIG. 5) of crimping cavity 69 that is adjacent to die mating plane 70 and is closer to pivot 61 (than its opposing lateral side) is longer than their counterpart lateral faces 73a, 73b (FIG. 5) on the other side of crimping cavity 69.

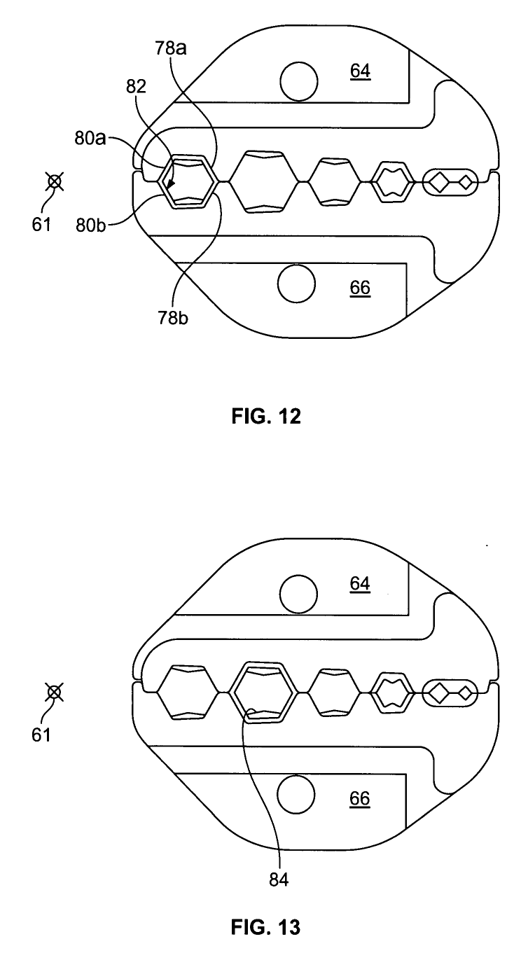

Configuring crimping cavity 69 as described with respect to FIGS. 5 and 6 causes the loading conditions on ferrule 71 at the beginning of the deformation process to be approximately equivalent at all of the initial contact points. Consequently, the initial contact points are substantially coincident with swage loads R, as shown in FIGS. 6-9. Thus, the distance between initial contact points 76a, 76b in the embodiment of FIG. 6 (which are disposed away from pivot 61) is approximately equal to the distance between initial contact points 74a, 74b (which are disposed close to pivot 61), After crimping, lateral cavity sides 78a, 78b (which are disposed away from pivot 61) are generally shorter than counterpart sides 80a, 80b (which are disposed close to pivot 61), as shown in FIG. 12. The finished sides of crimped ferrules 82, 84, 86 and 88 (FIGS. 12-15) are not symmetrical, as practiced in traditional crimping configurations, but are somewhat irregular due to the irregular configuration of the hexagonal cavities. The amount of flashing is reduced.

The crimping process of the present invention is illustrated in stages (semi-closed and fully closed) for a RG59 ferrule, a RG6 ferrule, a M59 ferrule, and a MHR ferrule in FIGS. 6 and 12, 7 and 13, 8 and 14, and 9 and 15, respectively. Respective irregular hexagonal crimping cavities 90, 92 and 94 are generally shown in FIGS. 6-8. In one or more embodiments, one or more crimping cavities do not have modified configurations.

In one or more embodiments, one or more of the ferrule crimping cavities has a projection (sometimes referred to as a spike detail) that is intended to provide additional deformation to the ferrule at the end furthest from the connector to further secure the ferrule to the cable jacket. Each of crimping cavities 90, 92, 94 and 96 (FIGS. 6-9) include a spike detail that secures ferrule to the cable jacket. The spike detail advantageously provides improved crimping capability by preventing the cable jacket from pulling out of the connector. Spike details 102, 104, 106 and 108 for RG59, RG6, M59 and MHR ferrule cavities 90, 92, 94 and 96, respectively, are shown, for example, in FIGS. 2A-2B.

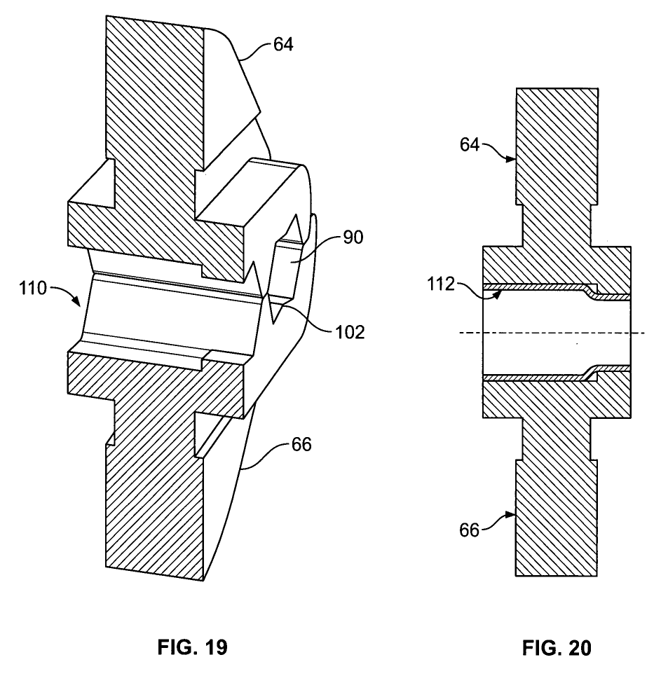

FIG. 19 shows a cross-section of a crimping cavity configured in accordance with one or more embodiments of the present invention. FIG. 20 illustrates a crimped ferrule 112 which has been deformed in accordance with one or more embodiments of the present invention.

BNC (Bayonet Neill-Concelman) connector ferrules are generally cylindrical in form. An MHR ferrule is typically configured as a cylinder that is necked down in size to a smaller cylinder at one end. An MHR connector requires the cavity neck portion to substantially grip the cable because the shield layer of wires that are crimped to the connector post are typically too small and weak to provide sufficient pull-out resistance alone. In one or more embodiments, cavities for MHR connectors are provided with a spike detail to securely grip the cable. An example of such a spike detail 108 is shown in FIGS. 2A and 2B.

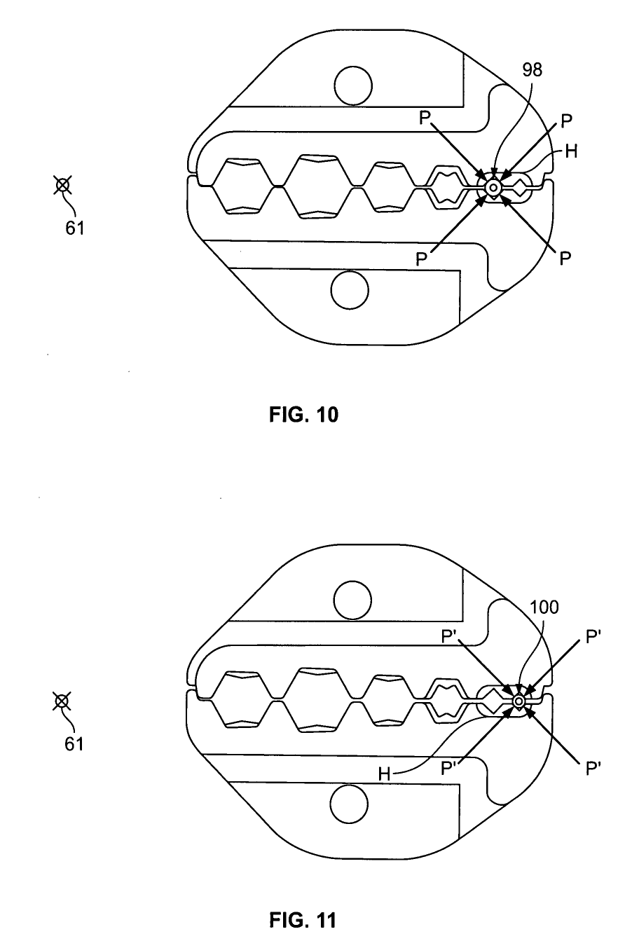

In one or more embodiments, core pin crimping cavities 98, 100 (FIGS. 10-11) are configured differently from ferrule crimping cavities 90, 92, 94 and 96 (FIGS. 6-9) in that instead of deforming the entire ferule, only a small section is pinched to secure the core conductor of the coaxial cable. Core pin crimping cavities 98, 100 (FIGS. 10-11) generally conform to traditional shapes and sizes except for the degree of curvature S at the junction of a respective die mating plane and its adjacent cavity side. In accordance with one or more embodiments of the present invention, junction curvature or radius S is made relatively smaller than traditional junction radius K to reduce undesirable flash, as shown in FIGS. 17-18.

In one or more embodiments, the depth of the pinch provided by core pin crimping cavities 98, 100 (FIGS. 10-11) is made substantially less than conventional crimping cavity depth. Conventional crimping cavity depth typically allows for crimping of the full length of the wire inserted into the pin. By crimping, however, only about half of the wire nearest the open end of the pin (when utilizing core pin cavities 98, 100), the wire is bottlenecked inside the pin which significantly increases the pull-out resistance.

A person skilled in the art would readily recognize that the present invention provides a multi-purpose cable crimping tool. Particularly, the various embodiments described hereinabove are merely illustrative of the general principles of the present invention. Various design or system modifications may be utilized as without departing from the scope of the invention. Thus, by way of example, but not of limitation, various alternative configurations may be utilized in accordance with the teachings herein. For example, although the illustrated embodiments use generally square and hexagonal cavities, other types of polygons and other geometric shapes may be used. Accordingly, the drawings and description are illustrative and not meant to be a limitation.

What is claimed is:

1. A cable crimping tool, comprising:
an upper die; and
a lower die operatively coupled to said upper die, said upper and lower dies configured to form jointly at least one cable crimping cavity, said at least one cable crimping cavity being generally configured as an irregular polygon.

2. The cable crimping tool of claim 1 comprising a plurality of cable crimping cavities.

3. The cable crimping tool of claim 2 wherein a plurality of said cable crimping cavities are generally configured as irregular polygons.

4. The cable crimping tool of claim 3 wherein said plurality of cable crimping cavities comprise cavities for crimping at least one of the group comprising RG59, RG6, M59 (Mini 59) and MHR (Mini Hi Rez) connectors.

5. The cable crimping tool of claim 4, wherein said plurality of cable crimping cavities further comprises cavities for crimping M59 and MHR/RG core pins.

6. The cable crimping tool of claim 1 wherein said polygon comprises a hexagon.

7. The cable crimping tool of claim 1 wherein said polygon comprises a quadrilateral.

8. The cable crimping tool of claim 1 wherein said at least one cable crimping cavity comprises a spike detail.

9. The cable crimping tool of claim 1 wherein said irregular polygon is configured so that distances between opposing contact points between said cavity and a connector being crimped are approximately equal.

10. The cable crimping tool of claim 1 wherein said irregular polygon is configured so that swage loads are approximately perpendicular to faces of said polygon.
